(19) United States
(12) Patent Application Publication
(10) Pub. No.: US 2009/0321669 A1
(43) Pub. Date: Dec. 31, 2009

(54) FLAPPER HOT GAS VALVE

(75) Inventors: Raymond R. Tseng, Chandler, AZ (US); Steve Abel, Chandler, AZ (US); Don Christensen, Phoenix, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/119,059

(22) Filed: May 12, 2008

(51) Int. Cl. F16K 31/02; F16K 1/16

(52) U.S. Cl. 251/129.2; 251/298; 251/129.15

(57) ABSTRACT

A gas valve apparatus is provided. A primary valve includes a flapper nozzle valve and first and second outputs. A secondary valve includes a housing having first and second inputs coupled to the first and second outputs of the primary valve, first and second seats coupled to the first and second inputs, first and second nozzles coupled to the first and second seats, and a moveable element configured for alternatively sealing the first and second nozzles as the moving element comes into contact with the first and second seats.

### FIELD OF THE INVENTION

The present invention generally relates to aerospace applications, and more particularly, to a flapper hot gas valve apparatus for aerospace implementations.

### BACKGROUND OF THE INVENTION

Multiple Kill Vehicles (MKV) carried onboard an interceptor may be implemented to counter a missile threat with multiple warheads. In order for the MKVs to be effectively packaged inside the interceptor, it is useful that they be as small in size as possible. Because of this size requirement, the size of the thermal battery used to power the MKV must also be correspondingly small, providing a limited amount of available electrical power.

Since MKVs are small in size, only small thruster valves are needed for movement. In one application, for example, the thrust level is only two (2) pound-force (Lbf). Use of a two-stage poppet valve including a ball poppet as the pilot stage and a piston poppet as the second stage for such an implementation may not be practical, as the flow requirement is so small that the mass flow from the pilot stage may be sufficient. In addition, fabrication of a piston ring at this size is difficult.

A single stage ball poppet valve (having one output) or a flapper nozzle valve (having two outputs) may encounter switching problems, as the differential pressure force may be too high for a solenoid to overcome (based on size and power requirements) when one side of valve is exposed to ambient pressure while the opposing side is exposed to supply pressure.

In addition, a single-stage flapper nozzle valve may also have offseat leakage problems, as ten percent to 30 percent offseat leakage may normally be observed in typical flapper nozzle valves. The high leakage may reduce the available thrust impulse and may not be acceptable. Finally, a single-stage ball poppet valve has only one output, and venting of the exhaust may pose an additional problem.

In summary, none of the conventional valve designs meet the stringent requirements of MKVs while maintaining a degree of simplicity and an ability to be mass produced without exorbitant expense. Accordingly a need exists for a gas valve design to alleviate the current issues described above. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment, by way of example only, a gas valve apparatus is provided. A primary valve includes a flapper nozzle valve and first and second outputs. A secondary valve includes a housing having first and second inputs coupled to the first and second outputs of the primary valve, first and second seats coupled to the first and second inputs, first and second nozzles coupled to the first and second seats, and a moveable element configured for alternatively sealing the first and second nozzles as the moving element comes into contact with the first and second seats.

In another embodiment, again by way of example only, a hot gas valve is provided. The gas valve includes first and second housings. A flapper nozzle valve is integrated into the first housing. First and second outputs are coupled to the flapper nozzle valve. First and second inputs are integrated into the second housing. First and second seats are coupled to the first and second inputs. First and second nozzles are coupled to the first and second seats. A movable element is configured for alternatively sealing the first and second nozzles as the moveable element comes into contact with the first and second seats.

In another embodiment, again by way of example only, a gas valve apparatus is provided. A pilot valve incorporates at least a portion of a flapper alternatively sealing first and second outputs of the pilot valve. A ball valve is coupled to the first and second outputs of the pilot valve. The ball valve incorporates a ball element and first and second ball seats. The ball element is configured to alternatively seal the first and second ball seats as the ball element comes into contact with the first and second ball seats.

In still another embodiment, again by way of example only, a gas valve apparatus is provided. A pilot valve incorporates at least a portion of a flapper alternatively sealing first and second outputs of the pilot valve. A disk valve is coupled to the first and second outputs of the pilot valve. The disk valve incorporates a disk element and first and second disk seats. The disk element is configured to alternatively seal the first and second disk seats as the disk element comes into contact with the first and second disk seats.

### BRIEF DESCRIPTION OF THE DRAWINGS

The present invention will hereinafter be described in conjunction with the following drawing figures, wherein like numerals denote like elements, and

FIG. 1 illustrates an exemplary flapper disk hot gas valve; and

FIG. 2 illustrates an exemplary flapper ball diverter valve.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present description and following claimed subject matter present exemplary embodiments of a hot gas valve apparatus. In some embodiments, a flapper nozzle valve is coupled to a disk valve having a disk shuttle between two disk seats. In other embodiments, the flapper nozzle valve is coupled to a ball valve having a ball shuttle between two ball seats. These embodiments eliminate the need for expensive precision wire Electro Discharge Manufacturing (EDM) and/or rhenium bonding. In these embodiments, the disk/ball with accompanying disk/ball seats provide two functions. First, offset leakage may be completely eliminated. Second, proper back pressure may be implemented at the back side of the flapper for robust switching. This reduces a solenoid force requirement and allows the use of a smaller, power-saving device.

Differential pressure force across the flapper may be minimized by design for small solenoid requirements. Because a smaller solenoid may be used, lower power consumption is realized. Without the addition of a ball or disk valve, one side of the flapper is exposed to ambient pressure. As a result, the differential pressure force across the flapper would be very high and would require a much bigger solenoid to switch.

The flapper nozzle valve incorporated into the illustrated embodiments may utilize at least a portion of proven pilot valve designs to increase reliability. Additionally, disk/ball housing, disk/ball and disk/ball seat designs may incorporate aspects of proven designs.

In a disk embodiment, disk impact jitter is small. The thickness of the disk may be configured to be thinner than 0.020″ (0.187″ diameter) for a 2 pound-force (Lbf) valve and 0.024″ (0.203 diameter) for a 3 pound-force (Lbf) valve. As the disk mass is small, the jitter will be negligible. Jitter in ball embodiments is also expected to be acceptable for similar reasons. The illustrated embodiments are fast in response. The 10% delay time is expected to be less than 1 millisecond (msec). In addition, the 80% thrust response time is expected to be less than 1.4 msecs and frequency response more than 1200 Hertz (Hz).

The following embodiments help to alleviate the issues previously described, while satisfying the stringent requirements of an MKV system, including (1) low electrical power consumption, (2) low cost, (3) high efficiency, including no offseat leakage, (4) small size, (5) fast response, and (6) mass producible (the required manufacturing tolerances of the design can be easily achieved without the need for an exotic manufacturing process), (7) low jitter, and (8) rugged and robust design.

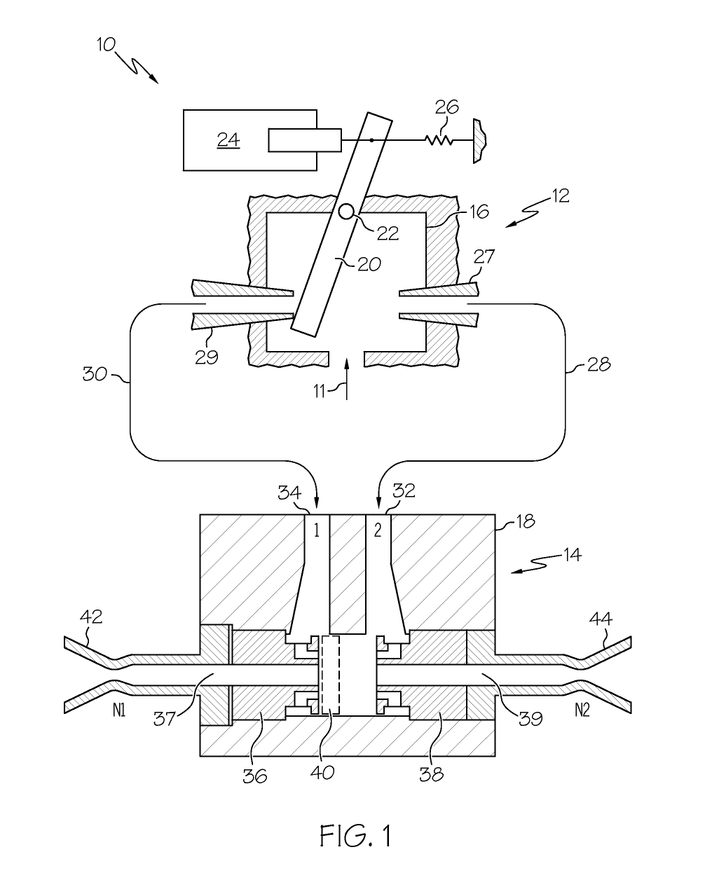

Turning to FIG. 1, an exemplary gas valve apparatus 10 is depicted. The apparatus 10 includes a primary (pilot) valve 12 and a secondary (disk) valve 14. The pilot valve is a flapper nozzle valve that includes a housing 16, one flapper 20 pivoting at a pivot point 22, two output nozzles 27, 29, one solenoid 24 and one spring 26. The disk valve 14 includes a housing 18, a disk 40, two disk seats 36, 38 and two thruster nozzles N1 and N2 (42, 44). The pilot valve 12 has one input port 11 and two output ports 28, 30. The disk valve 14 has two input ports 32, 34 that connect to the two output ports 28, 30 of the pilot valve. The two output ports 37, 39 of the disk valve 14 connect to the two thruster nozzles N1 and N2 (42, 44).

At de-energized condition as shown in FIG. 1, the flapper 20 of the pilot valve 12 is pulled (actuated) by the spring 26 to block pilot valve output 1 (30), and the pilot valve input port 11 (supply pressure) is connected to the pilot valve output 2 (28) that connects to the input port 2 (32) of the disk valve 14. High pressure at input port 2 (32) of the disk valve 14 pushes the disk 40 toward left to rest against the left seat (disk seat 36) to allow the flow through the right thruster N2 (44). No leakage flow at the N1 side is expected as the disk is pushed by the pressure force to seat against the disk seat 36.

To switch the flow to the left thruster (N1 side) from right thruster (N2 side), the solenoid 24 has to be energized to actuate the flapper 20 in the opposite direction. To initiate the switch, the solenoid force has to overcome the spring, friction, and suction force across the flapper 20. The suction force of the flapper 20 is the differential pressure force across the flapper 20. The differential pressure is significantly reduced when the pilot valve output 30 is back pressured by the disk valve 14 as shown. This reduces the solenoid force requirement for switching, thus reducing the electrical power consumption by the solenoid 24.

An additional benefit of a smaller solenoid 24 is faster response. Use of a smaller solenoid 24 has an accompanying smaller electrical time constant. Accordingly, the smaller solenoid responds more quickly than a bigger solenoid.

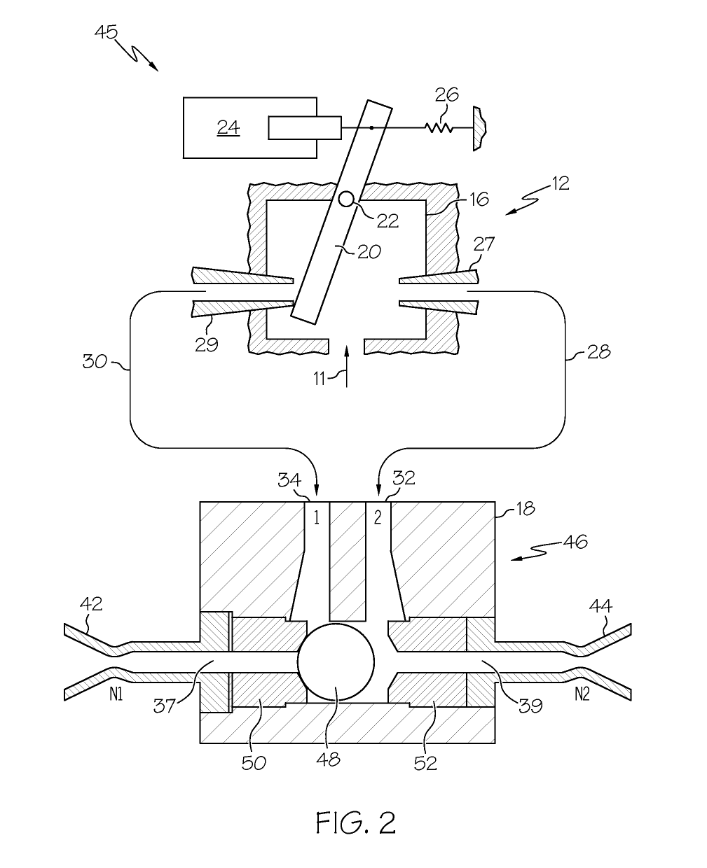

FIG. 2, following, illustrates an additional exemplary embodiment of a gas valve apparatus 45. Apparatus 45 includes a primary (pilot) valve 12 and a secondary (ball) valve 46. The elements comprising the primary valve for apparatus 45 are similar to that illustrated in FIG. 1, including input 11, housing 16, flapper 20, pivot point 22, solenoid 24, spring 26, nozzles 27, 29, and outputs 28, 30. Secondary valve 46 in the depicted embodiment is a ball valve 46. The moveable disk element 40 (FIG. 1) is replaced by a moveable ball element 48 alternatively sealing ball seats 50, 52 in similar fashion to the disk embodiment of FIG. 1.

In similar fashion to apparatus 10, the outputs 28, 30 of valve 12 are coupled to the inputs 32, 34 of valve 46. At de-energized condition as shown in FIG. 2, the flapper 20 of the pilot valve 12 is pulled by the spring 26 to block pilot valve output 1 (30), and the pilot valve input port 11 (supply pressure) is connected to the pilot valve output 2 (28) that connects to the input port 2 (32) of the ball valve 46. High pressure at input port 2 (32) of the ball valve 46 pushes the ball 48 toward left to rest against the left seat (ball seat 50) to allow the flow through the right thruster N2 (44). No leakage flow at the N1 side is expected as the ball is pushed by the pressure force to seat against the ball seat 50.

Here as before, to switch the flow to the left thruster (N1 side) from right thruster (N2 side), the solenoid 24 has to be energized. To initiate the switch, the solenoid force has to overcome the spring, friction, and suction force across the flapper 20. The differential pressure is significantly reduced when the pilot valve output 30 is back pressured by the ball valve 46 as shown. This reduces the solenoid force requirement for switching, thus reducing the electrical power consumption by the solenoid 24.

The performance of either disk or ball embodiments are expected to be very close to each other. Compared with the disk valve design, the ball 48 has greater mass than the disk 40 (FIG. 1), and the response time may be slower. However, the response time difference may be insignificant (in the order of 0.1 msec) and is acceptable with the ball design. The jitter from the ball design may be slightly higher than the disk design. However, it is not expected to be a problem in most of the applications since the ball 48 is still relatively small. An advantage of a ball embodiment is that the ball bore clearance change is smaller than a disk embodiment during hot operation. In a disk embodiment, the disk housing has a much greater thermal mass than the disk itself. This mismatch may result in changes in disk bore clearance affecting performance during hot operation. As the performance of the depicted embodiments may be sensitive to disk or ball bore clearances, additional embodiments may vary these clearances in design for a particular implementation, as the skilled artisan will appreciate.

The thermal mass of the ball and the ball housing can be designed to match or closely match to each other to minimize the ball bore clearance variation at hot temperatures. This minimizes the difference of the valve performance between hot and cold. This is highly desirable in the design because this allows the verification of the valve at hot with a cold gas test. A hot gas valve design that cannot be verified with a cold gas test is almost impossible to develop.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are described to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While one or more embodiments of the present invention have been illustrated in detail, the skilled artisan will appreciate that modifications and adaptations to those embodiments may be made without departing from the scope of the present invention as set forth in the following claims.

What is claimed is:

1. A gas valve apparatus, comprising:
a primary valve, the primary valve including a flapper nozzle valve and first and second outputs; and
a secondary valve, the secondary valve including a housing having first and second inputs coupled to the first and second outputs of the primary valve, first and second seats coupled to the first and second inputs, first and second nozzles coupled to the first and second seats, and a moveable element configured for alternatively sealing the first and second nozzles as the moving element comes into contact with the first and second seats.

2. The gas valve apparatus of claim 1, wherein:
the moveable element is a disk,
the secondary valve is a disk valve, and
the first and second seats are first and second disk seats.

3. The gas valve apparatus of claim 1, wherein:
the moveable element is a ball,
the secondary valve is a ball valve, and
the first and second seats are first and second ball seats.

4. The gas valve apparatus of claim 1, further including:
a solenoid coupled to the flapper nozzle valve for actuating a flapper in a first direction, and
a spring coupled to the flapper nozzle valve for actuating the flapper in a second direction.

5. The gas valve apparatus of claim 2, wherein a thickness of the disk is less than 0.020 inches for a 2 pound-force (Lbf) thrust-rated valve, and less than 0.024 inches for a 3 pound-force (LBf) thrust-rated valve.

6. A hot gas valve, comprising:
first and second housings;
a flapper nozzle valve integrated into the first housing;
first and second outputs coupled to the flapper nozzle valve;
first and second inputs integrated into the second housing;
first and second seats coupled to the first and second inputs;
first and second nozzles coupled to the first and second seats; and
a movable element configured for alternatively sealing the first and second nozzles as the moveable element comes into contact with the first and second seats.

7. The hot gas valve of claim 6, further including first and second nozzles coupled to the first and second seats.

8. The hot gas valve of claim 6, wherein the moveable element is one of a disk and a ball.

9. The hot gas valve of claim 6, wherein the first and second seats are one of first and second disk seats and first and second ball seats.

10 The hot gas valve of claim 6, further including a solenoid coupled to the flapper nozzle valve for actuating a flapper in a first direction.

11. The hot gas valve of claim 6, further including a spring coupled to the flapper nozzle valve for actuating a flapper in a first direction.

12. The hot gas valve of claim 6, wherein the moveable element is a disk having a thickness of less than 0.020 inches for a 2 pound-force (Lbf) thrust-rated valve, and less than 0.024 inches for a 3 pound-force (Lbf) thrust-rated valve.

13. The hot gas valve of claim 6, further including a supply input integrated into the first housing for receiving a supply of gas.

14. A gas valve apparatus, comprising:
a pilot valve incorporating at least a portion of a flapper alternatively sealing first and second outputs of the pilot valve; and
a ball valve coupled to the first and second outputs of the pilot valve, the ball valve incorporating a ball element and first and second ball seats, the ball element configured to alternatively seal the first and second ball seats as the ball element comes into contact with the first and second ball seats.

15. The gas valve apparatus of claim 14, further including first and second nozzles coupled to the first and second ball seats.

16. The gas valve apparatus of claim 14, further including:
a solenoid coupled to the flapper for actuating the flapper in a first direction, and
a spring coupled to the flapper for actuating the flapper in a second direction.

17. A gas valve apparatus, comprising:
a pilot valve incorporating at least a portion of a flapper alternatively sealing first and second outputs of the pilot valve; and
a disk valve coupled to the first and second outputs of the pilot valve, the disk valve incorporating a disk element and first and second disk seats, the disk element configured to alternatively seal the first and second disk seats as the disk element comes into contact with the first and second disk seats.

18. The gas valve apparatus of claim 17, further including first and second nozzles coupled to the first and second disk seats.

19. The gas valve apparatus of claim 17, further including:
a solenoid coupled to the flapper for actuating the flapper in a first direction, and
a spring coupled to the flapper for actuating the flapper in a second direction.
